(19) United States
(12) Patent Application Publication
(10) Pub. No.: US 2012/0132553 A1
(43) Pub. Date: May 31, 2012

(54) Gun storage device

(76) Inventor: Robert Verheyen, Phoenix, AZ (US)

(21) Appl. No.: 13/199,255

(22) Filed: Aug. 24, 2011

Related U.S. Application Data
(60) Provisional application No. 61/417,709, filed on Nov. 29, 2010.

(51) Int. Cl. B65D 85/00; B29C 51/42

(52) U.S. Cl. 206/317; 264/161

(57) ABSTRACT

The tool storage device having a member formed as a longitudinally bifurcated holder having a top portion; a right sidewall that runs vertical and the length of the holder; a left sidewall that is positioned parallel to an upper portion of the right sidewall; an angled left sidewall connected to the left sidewall at an angle from the left sidewall and toward the right sidewall; a curved sidewall connecting the angled left sidewall and the right sidewall, wherein: the right sidewall, the left sidewall, the angled left sidewall, and the curved sidewall each connect a flange and the top portion; and an internal cavity defined by the top portion, the plane defined by the flange, the right sidewall, the left sidewall, the angled left sidewall, and the curved sidewall, and said flange circumscribing the periphery of the holder, wherein the flange is formed to confirming fit with a surface.

The present invention claims priority based upon previously file provisional patent application Ser. No. 61/417,709 filed on Nov. 29, 2010.

### TECHNICAL FIELD

The present invention relates to a firearm holder and, more particularly, to a handgun holder, and most particularly, to a universal handgun holder that is configurable to adapt to handguns of a variety of dimensions and for multiple applications, such as storage, rapid access, or a combination thereof.

### BACKGROUND ART

Many individuals possess handguns for the purpose of self-defense. These include, for example, shop owners, cashiers, homeowners, and drivers. In order to provide effective self-defense, the handgun must be readily available, positioned for rapid access, and, in some instances, concealed. Oftentimes handguns are holstered to provide rapid access. However, when exposed to a threat, removing a concealed handgun from a holster generally requires an individual to insert his hand into a pocket on his clothing, remove the strap securing the gun, if one is present, and extracting the handgun. These actions take precious time and involve motions that are likely to alert the person or persons posing the threat, thereby diminishing or eliminating the intended self-defense function of the handgun. In addition, if the individual is seated, a pocketed and holstered handgun is less readily available because the contents of the pocket are less accessible in the seated position. An exposed, belt-holstered handgun is also less readily available in the seated position because of the position of the individual's body and, in the case of a vehicle, the limited freedom of movement.

Many individuals possessing a handgun for self-defense generally remain within a defined spatial area. As such, these individuals oftentimes store a handgun in a nearby drawer or on a shelf where it is within reach and can be easily accessed. The action of accessing a handgun from one of these locations, as opposed to a holster and/or pocket, may provide quicker access and may better allow the individual to present the handgun without alerting the person or persons posing the threat. In this situation, however, the handgun is not in a defined or predictable orientation or location. When accessed, the individual must reach for the handgun, find the exact location of the handgun, assess its orientation, grip it appropriately, and only then present it for use. This unpredictability in location and orientation can cost precious seconds and diminish or eliminate the intended self-defense function of the handgun.

Handguns are often stored in relatively large containers, such as, for example, briefcases, storage boxes, safes, and car consoles. Because these containers are generally much larger than the handgun, the handgun can move around freely within the container. This is undesirable in some situations because the free movement of the handgun may create a safety hazard and/or may result in damage to the handgun by exposing it to scratching and/or dirt and grit. The handgun may be stored in a case or holster for protection and safety, however, the handgun and the case or holster can move freely within the large container. A handgun stored in such a container is not appropriate for rapid deployment applications due to the time necessary to locate the handgun within the container, assess its orientation, and, if necessary, remove it from its case or holster.

In other situations, an individual may prefer not to store a handgun on top of a horizontal surface where it can take up precious work or storage space. For example, a shop keeper or a mechanic may not have available space on a shelf, countertop, or work bench to store the handgun. Alternately, such an individual may want the handgun stored in a concealed manner.

It would therefore be an advance in the state of the art to provide an inexpensive apparatus for fixing a handgun to a surface, wherein the apparatus is configurable to universally accept a handgun of nearly any shape and size, and that allows the handgun to be positioned in a fixed and concealed location and in a predictable and known orientation. And, wherein, the apparatus is configurable to allow rapid access, which enables the handgun to be nearly instantaneously extracted and operatively presented, maximizing its self-defense function.

### SUMMARY OF THE INVENTION

It is an object of the present invention to provide a device and method for the storing a hand tool, such as a firearm, on a surface.

It is another object of the present invention to provide a device and method for the storing a hand tool, such as a firearm, on a substantially planar surface.

It is a further object of the present invention to provide a device and method for the storing a hand tool, such as a firearm, on a substantially planar surface, wherein the device is secured to the substantially planar surface via a substantially planar flange that circumscribes a majority of the periphery of the device

It is yet another object of the present invention to provide a small portable device for the transport of lengthy objects that is foldable for easy storage.

The novel features that are considered characteristic of the invention are set forth with particularity in the appended claims. The invention itself, however, both as to its structure and its operation together with the additional object and advantages thereof will best be understood from the following description of the preferred embodiment of the present invention when read in conjunction with the accompanying drawings. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments is not intended to indicate a desire to invoke the special provision of 35 U.S.C. §112, paragraph 6 to define the invention. To the contrary, if the provisions of 35 U.S.C. §112, paragraph 6, are sought to be invoked to define the invention(s), the claims will specifically state the phrases “means for” or “step for” and a function, without also reciting in such phrases any structure, material, or act in support of the function. Even when the claims recite a “means for” or “step for” performing a function, if they also recite any structure, material or acts in support of that means of step, then the intention is not to invoke the provisions of 35 U.S.C. §112, paragraph 6. Moreover, even if the provisions of 35 U.S.C. §112, paragraph 6, are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, materials or acts for performing the claimed function.

### BRIEF DESCRIPTION OF THE DRAWINGS

The invention will be more fully understood by referring to the following Detailed Description of Specific Embodiments in conjunction with the Drawings, of which:

FIG. 1 is a perspective drawing of a front view of a right-handed variation of one embodiment of Applicant's handgun holder;

FIG. 2 is a perspective drawing of a side view of the embodiment of Applicant's handgun holder shown in FIG. 1.

FIG. 3 is a perspective drawing of the top view of the embodiment of Applicant's handgun holder shown in FIG. 1;

FIG. 4 is a perspective drawing of the underside view of one embodiment of Applicant's handgun holder;

FIG. 5 is a perspective drawing of a front view of a left-handed variation of one embodiment of Applicant's handgun holder;

FIGS. 6(a)-6(e) are representations of various embodiments of Applicant's handgun holder configured for various guns and for various purposes;

FIG. 7(a)-7(d) are representations of various installations of Applicant's handgun holder;

FIG. 8 is a flowchart showing the steps of an exemplary method of making Applicant's handgun holder; and

FIG. 9 is a flowchart showing the steps of an exemplary method of configuring Applicant's handgun holder.

### DETAILED DESCRIPTION OF SPECIFIC EMBODIMENTS

In certain embodiments, Applicant's handgun holder enables a handgun of nearly any size and shape to be mounted on practically any flat surface. In certain embodiments, Applicant's gun may also be easily customized to better fit the gun and/or to provide for rapid access.

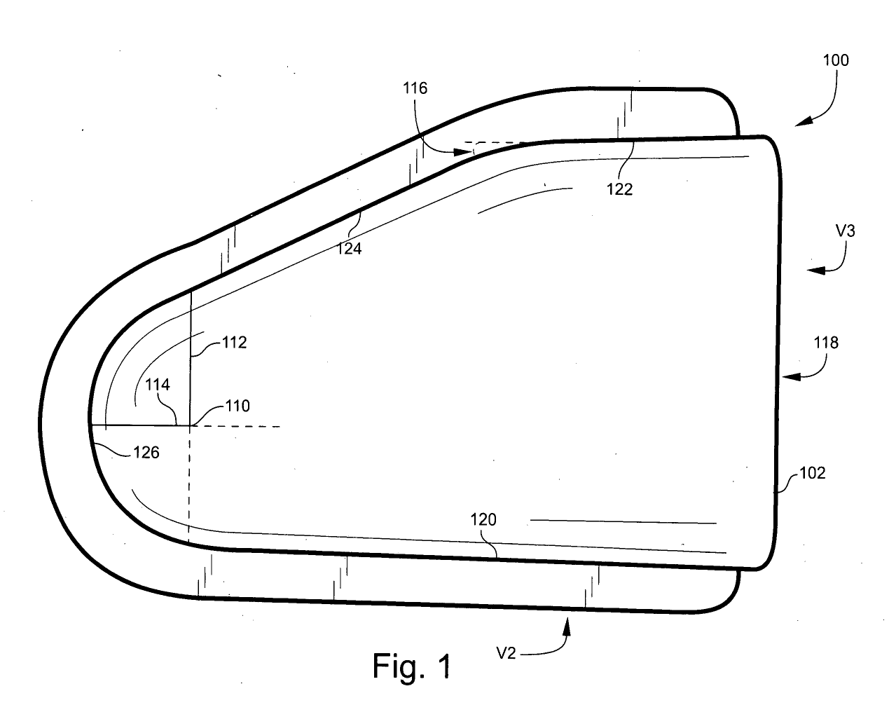

Referring to FIG. 1, the front view of one embodiment of Applicant's handgun holder 100 is depicted. In one embodiment, the handgun holder 100 is comprised of a single piece of a flexible material. In one embodiment, the handgun holder comprises a thermoplastic. In different embodiments, the handgun holder comprises a polycarbonate, acrylonitrile butadiene styrene (ABS), high-density polyethylene (HDPE), polyethylene terephthalate (PET), polyvinyl chloride (PVC), low-density polyethylene (LDPE), polypropylene (PP), or polystyrene (PS).

A flange 104 encircles all but one side of the handgun holder 100. The flange 104 lies along a single plane. In one embodiment, the flange has a consistent width. The body portion 102 is raised away from the plan of the flange 104 to form an interior cavity (not visible, but the opening to the interior cavity is indicated by 118). The interior cavity is sized to accept handguns of various dimensions.

In one embodiment, the sidewall 120 is approximately perpendicular to the flange 104 and extends outward from the image. The sidewall 120 runs, in this view, substantially horizontal along the handgun holder 100. In one embodiment, the sidewall 122 is approximately perpendicular to the flange 104. In one embodiment, the sidewall 122 runs substantially parallel to sidewall 120. In one embodiment, the sidewall 124 is approximately perpendicular to the flange 104. The sidewall 124 runs from sidewall 122 at approximately an angle 116 from sidewall 122. Sidewall 120 and sidewall 124 are joined by sidewall 126. Sidewall 126 is curved and approximated by an ellipse with a center 110, semimajor axis 112, and a semiminor axis 114.

In one embodiment, the angle 116 is between 20° and 30°. In one embodiment, the horizontal dimension 108 can be within the range of about 4 inches to about 12 inches. In one embodiment, the flange width 128 can be within the range of 0.375 inches to 1 inch. In different embodiments, the handgun holder 100 has a horizontal dimension 108 that is 1.333 times the vertical dimension 106, a semiminor axis 112 that is 0.1875 times the vertical dimension 106, and a semimajor axis 114 that is 0.2207 times the vertical dimension 106. In one embodiment, the handgun holder 100 is sized to fit a particular handgun.

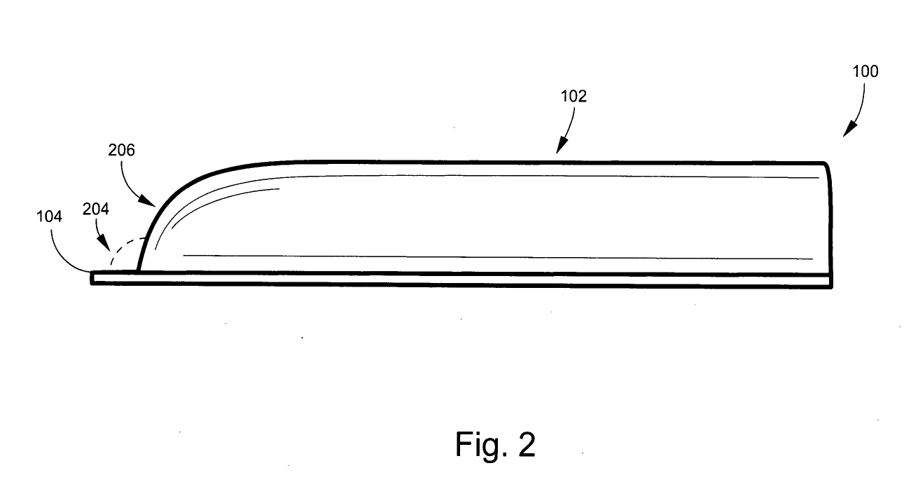

Referring to FIG. 2, the side view of the embodiment of Applicant's handgun holder 100 in FIG. 1, from view V2 of FIG. 1, is depicted. The flange 104 lies along a plane. The body portion 102 rises from the flange 104. The body portion 102 includes sidewall 120 and curved sidewall 126. The curved sidewall 126 is connected with the flange 104 at an angle 204. The sidewall 126 curves 206 into the substantially horizontal portion of the body portion 102. An interior cavity (not visible, but the opening to the interior cavity is indicated by 118) is formed by the body portion 102. This is most pronounced for revolvers, which have a wide body relative to the barrel. The raised handle better positions the inserted gun (not shown) for retrieval and is especially beneficial for rapid access applications. In one embodiment, dimension 202 may be within the range of about 1 inch to about 2 inches. In one embodiment, the angle may be within the range of about 30° to about 80°.

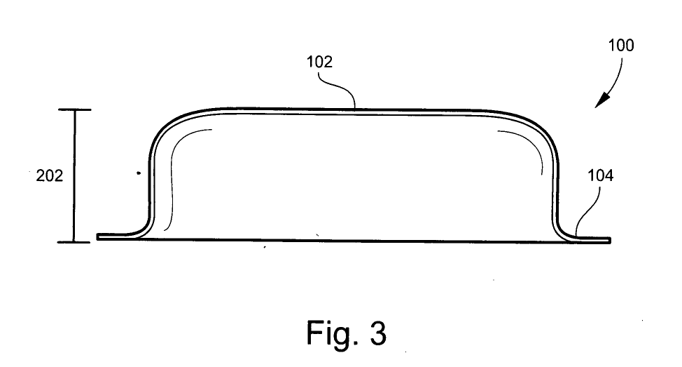

Referring to FIG. 3, the side view of the embodiment of Applicant's handgun holder 100 in FIG. 1, from view V3 of FIG. 1, is depicted. The flange 104 lies along a plane. The body portion 102 rises from the flange 104. The sidewall 120 and sidewall 122 define an interior cavity. The cavity is defined by the body portion 102 and the plane of the flange 104. The portion opposite the body portion 102 is open. Mounting the handgun holder 100 to a surface, such as a shelf, a wall, or the underside of a counter, creates a cavity between the body portion 102 and the surface that is enclosed on all sides except the opening to the interior cavity 118. The opening to the interior cavity 118 and the interior cavity itself are sized to accept handguns of various dimensions.

In different embodiments, the handgun holder 100 is mounted to a surface by piecing the flange, such as by rivets, screws, nails, or combinations or equivalents thereof. In different embodiments, the handgun holder 100 is mounted to a surface without piercing the flange, such as by glue, tape, or combinations or equivalents thereof. In different embodiments, the handgun holder 100 is removably mounted to a surface, such as by a hook and loop fastener.

In one embodiment, the distance 202 between the majority of the body portion 102 and the flange 104 is sized to smaller than the maximum width of the contained handgun. The body portion 102, being constructed of flexible material, flexes when the handgun is inserted into the opening of the internal cavity 118 and subsequently applies sufficient pressure to retain the handgun until it is withdrawn. The particular mounting type is chosen to provide a connection of sufficient strength between the flange 104 of the handgun holder 100 and the mounting surface to securely hold the handgun holder 100 and a contained handgun.

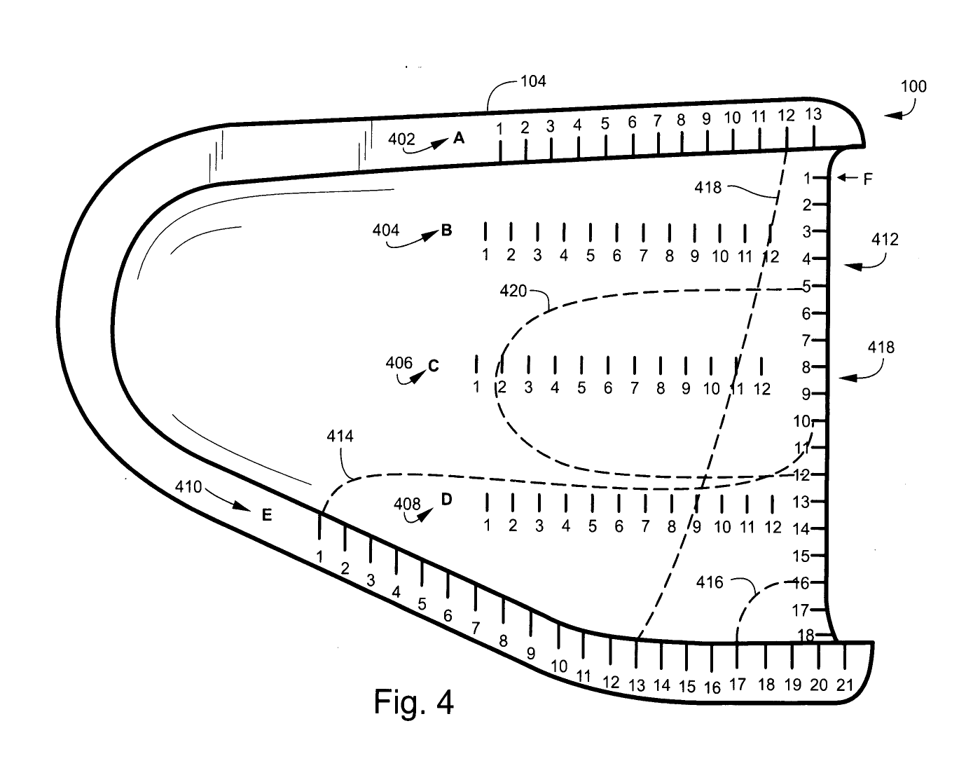

Referring to FIG. 4, a view of the underside of the embodiment of Applicant's handgun holder 100 in FIG. 1 is depicted. The body portion 102 rises away from the plane formed by flange 104, forming an internal cavity, whose opening is indicated by 118. Because the flange 104 defines a plane that is open in the middle, the interior of the body portion 102 is visible from this view. In one embodiment, the underside of the handgun holder 100 includes configuration mark sets 402, 404, 406, 408, 410, and 412. In one embodiment, configuration mark set 402, labeled as “A,” is on the flange 104 and includes ticks from 1 to 13. In one embodiment, configuration mark set 404, labeled as “B,” is on the underside of the body portion 102 and includes ticks from 1 to 12. In one embodiment, configuration mark set 406, labeled as “C,” is on the underside of the body portion 102 and includes ticks from 1 to 12. In one embodiment, configuration mark set 408, labeled as “D,” is on the underside of the body portion 102 and includes ticks from 1 to 12. In one embodiment, configuration mark set 410, labeled as “E,” is on the flange 104 and includes ticks from 1 to 21. In one embodiment, configuration mark set 412, labeled as “F,” is on the underside of the body portion 102 and includes ticks from 1 to 18.

The configuration mark sets 402, 404, 406, 408, 410, and 412 enable the use of five sets of identifiers to define the accurate modification of the handgun holder 100 to fit practically any size handgun and to adapt to multiple applications. In some embodiments, the configuration mark sets 402, 404, 406, 408, 410, 412 assist in customizing the handgun holder 100 for a particular handgun. In some embodiments, the configuration mark sets 402, 404, 406, 408, 410, 412 assist in customizing the handgun holder 100 for a secure storage application. In some embodiments, the configuration mark sets 402, 404, 406, 408, 410, 412 assist in customizing the handgun holder for rapid access applications. In some embodiments, the configuration mark sets 402, 404, 406, 408, 410, 412 assist in customizing the handgun holder for a balance between secure storage and rapid access qualities. As such, the handgun holder 100 is a universal and multi-purpose gun holding device.

In alternative embodiments, configuration mark sets may be projected or temporarily placed upon the holster and then removed after the configuration lines have been cut.

In one embodiment, customizing the handgun holder 100 involves identifying a number of points from two or more configuration mark sets 402, 404, 406, 408, 410, and 412. For example, to customize the handgun holder 100 for a medium handgun, such as a 38 Special with a barrel of approximately 3 inches, line 418 would be defined by A12, B12, C11, D9, and E13. The handgun holder 100 would be cut along line 418 for this application. Alternately, in another embodiment, a similar line can be designated by A12 and E13.

In one embodiment, to customize the handgun holder 100 for a rapid access configuration for a small handgun, such as a Rossi 38 Special with a barrel of approximately 1.5 inches, line 414 would be defined by F10, F12, and E1. The handgun holder 100 would be cut along line 414 for this application.

In one embodiment, to customize the handgun holder 100 for a rapid access configuration for a medium or large handgun, such as a Glock 40 caliber with a 6 inch barrel, line 420 would be defined by F5, C2, and F12. The handgun holder 100 would be cut along line 420 for this application.

In one embodiment, to customize the handgun holder 100 for a secure storage configuration for a medium or large handgun, such as a Colt 45 caliber government model 1911, line 416 would be defined by F16 and E17. The handgun holder 100 would be cut along line 416 for this application.

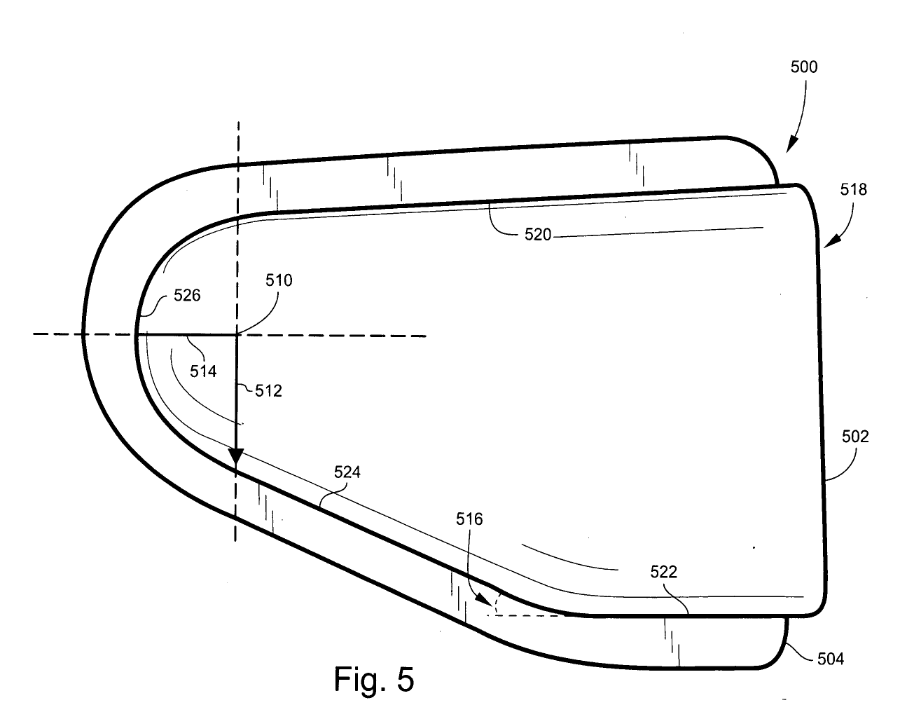

Referring to FIG. 5, a front view of one embodiment of a left-handed version of Applicant's handgun holder 500 is depicted. This embodiment, 500, is a mirror image of the embodiment, 100, in FIG. 1. A flange 504 wraps around a majority of the handgun holder 500. The flange 504 defines a plane. The body portion 502 rises away from the plane defined by the flange 504.

In one embodiment, the sidewall 520 is approximately perpendicular to the flange 504. The sidewall 520 runs, in this view, substantially horizontal along the handgun holder 500. In one embodiment, the sidewall 522 is approximately perpendicular to the flange 504. In one embodiment, the sidewall 522 runs substantially parallel to sidewall 520. In one embodiment, the sidewall 524 is approximately perpendicular to the flange 504. The sidewall 524 runs from sidewall 522 at approximately an angle 516 from sidewall 522. Sidewall 520 and sidewall 524 are joined by sidewall 526. Sidewall 526 is curved and approximated by an ellipse with a center 510, semimajor axis 512, and a semiminor axis 514.

In one embodiment, the horizontal dimension 508 can be within the range of about 4 inches to about 12 inches. In one embodiment, the flange width 528 can be within the range of 0.375 inches to 1 inch. In different embodiments, the handgun holder 500 has a horizontal dimension 508 that is 1.333 times the vertical dimension 506, a semiminor axis 512 that is 0.1875 times the vertical dimension 506, and a semimajor axis 514 that is 0.2207 times the vertical dimension 506. In one embodiment, the handgun holder 500 is sized to fit a particular handgun.

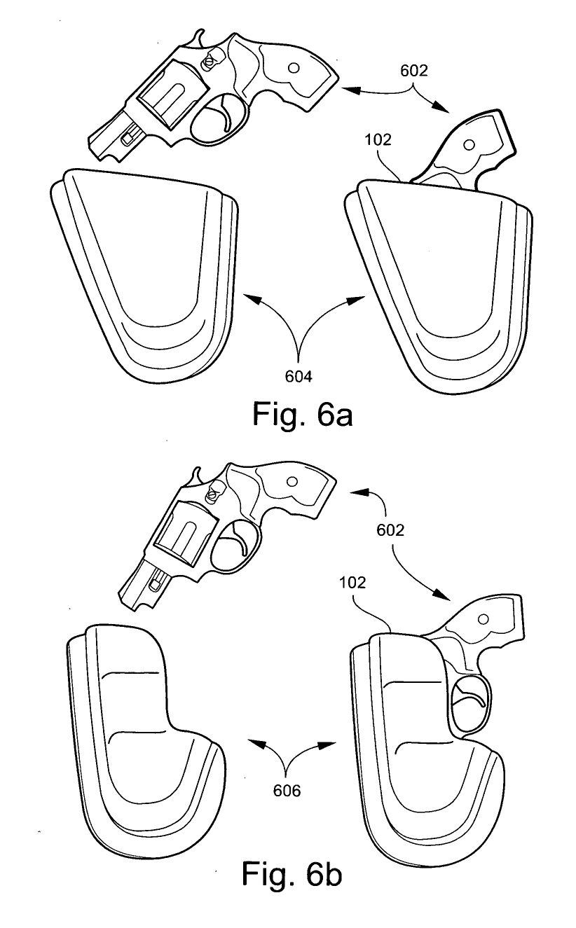

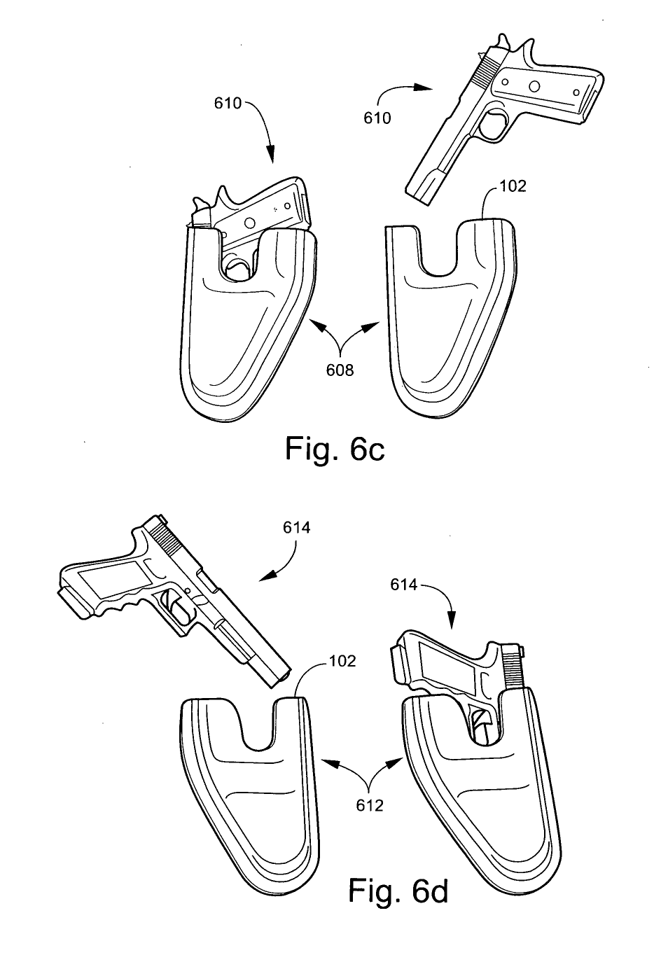

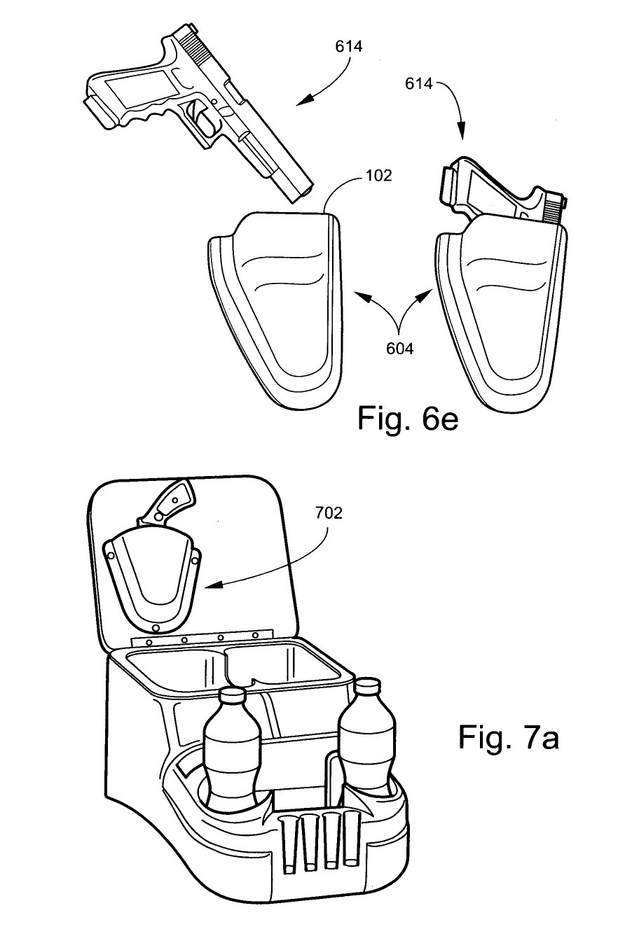

Referring to FIGS. 6(a)-6(e), photographs of various embodiments of Applicant's handgun holder 100 and 500, configured for different handguns and uses, are depicted. Referring to FIG. 6(a), a Rossi 38 Special 602 is shown both in and out of a left-handed version of the customized handgun holder 604. The customized handgun holder 604 is configured for a secure storage application. In this configuration, the body portion 102 covers substantially all of the body of the gun 602 while leaving the handle exposed. This provides for maximum stability at the expense of accessibility.

Referring to FIG. 6(b), the Rossi 38 Special 602 is shown both in and out of a right-handed version of the customized handgun holder 606. The customized handgun holder 606 is configured for a rapid access application. In this configuration, the body portion 102 covers a portion of the gun 602 while leaving the entire handle, trigger, and trigger guard exposed. The gun can be very quickly deployed because (i) the curve 206 and angle 204 (shown in FIG. 2) raise the handle away from the mounting surface and (ii) the entire handle and trigger are exposed allowing the gun 602 to be immediately accessed in an operative position. As compared to customized handgun holder 604 in FIG. 6(a), configuration 606 provides for maximum accessibility at the expense of stability.

Referring to FIG. 6(c), a Colt 911 45 caliber government model 1911 610 is shown both in and out of a left-handed version of the customized handgun holder 608. The customized handgun holder 608 is configured for a rapid access application. In this configuration, the body portion 102 covers a portion of the gun 610 while leaving the entire handle and trigger exposed. As such, the gun 610 can be immediately accessed in an operative position. This configuration 608 provides for both maximum accessibility and very high stability because substantially all of the gun 610 is covered, yet the trigger is exposed.

Referring to FIG. 6(d), a Glock 40 caliber with a 6 inch barrel 614 is shown both in and out of a right-handed version of the customized handgun holder 612. The customized handgun holder 612 is configured for a rapid access application. In this configuration, the body portion 102 covers a portion of the gun 614 while leaving the entire handle and trigger exposed. As such, the gun 614 can be immediately accessed in an operative position. This configuration 612 provides for both maximum accessibility and very high stability because substantially all of the gun 614 is covered, yet the trigger is exposed.

Referring to FIG. 6(e), a Glock 40 caliber with a 6 inch barrel 614 is shown both in and out of a right-handed version of the customized handgun holder 618. The customized handgun holder 604 is configured for a secure storage application. In this configuration, the body portion 102 covers substantially all of the body of the gun 614 while leaving only the handle exposed. This provides for maximum stability at the expense of accessibility.

The embodiment of Applicant's handgun holder shown in FIG. 1 (for right-handed users) or in FIG. 2 (for left-handed users) is capable of being easily modified to each of the configurations depicted in FIGS. 6(a)-6(e).

In different embodiments, a cover is disposed over the handle and other exposed portions of the handgun housed in Applicant's gun holder to better conceal the handgun and/or to comply with local concealed weapon laws. In one embodiment, the cover comprises a fabric flap. In one embodiment, the cover comprises a molded plastic material. Referring to FIGS. 10(a) and 10(b), one embodiment of a cover for Applicant's handgun holder is depicted. In FIG. 10(a), the cover 1002 is shown removed from the gun holder 1004, which is housing a handgun 1006. In FIG. 10(b), cover 1002 is shown disposed over the exposed portions of the handgun 1006 and a portion of the handgun holder 1004. In this position, the cover 1002 completely covers and conceals the handgun 1006 housed in the handgun holder 1004. In one embodiment, the cover 1002 comprises the same material at handgun holder 1004 and manufactured in the same manner as handgun holder 1004. In one embodiment, the cover 1002 is sized to completely conceal the exposed portions of any handgun disposed in Applicant's handgun holder.

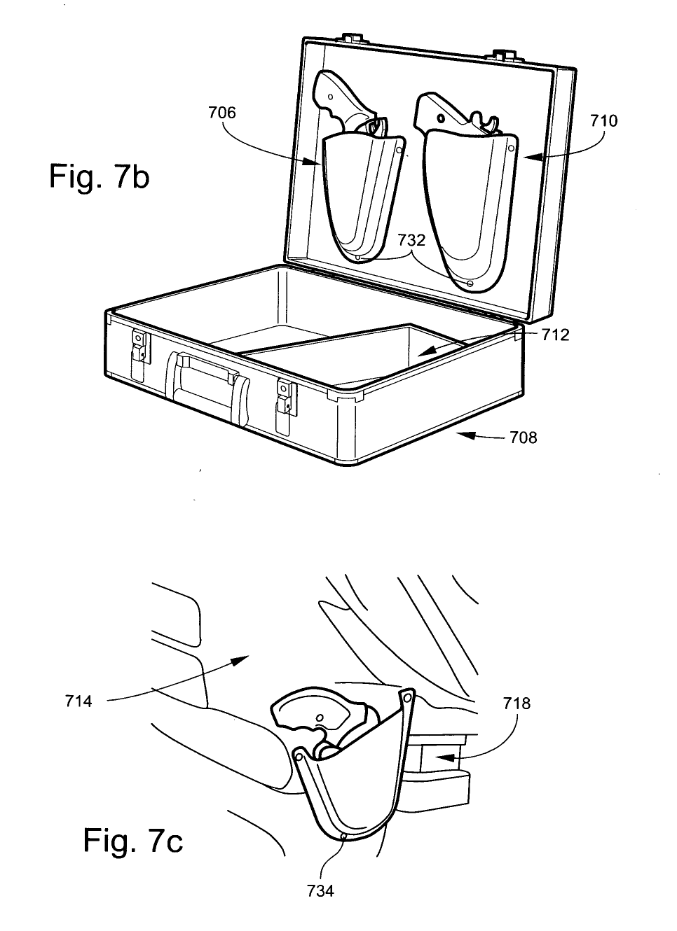

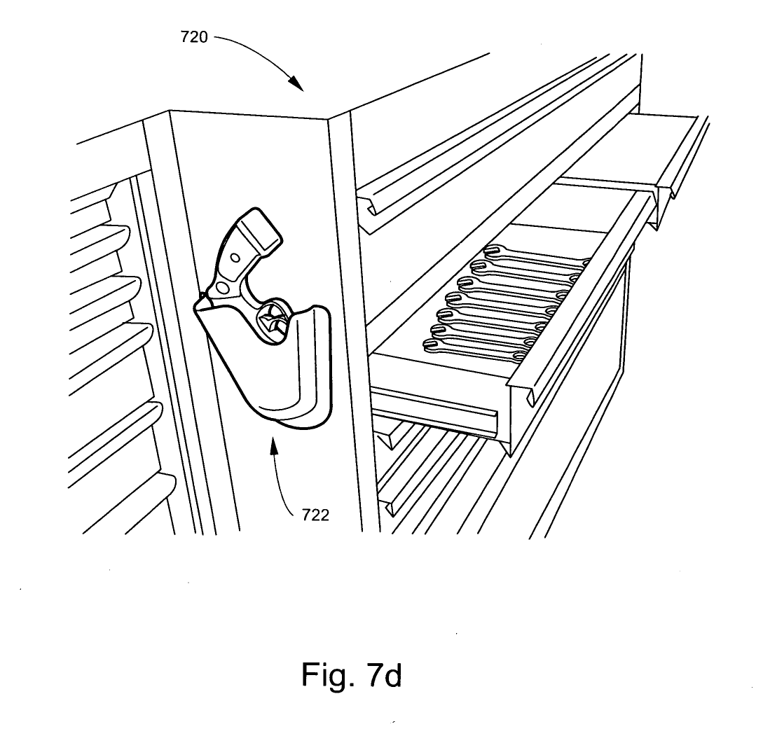

Referring to FIGS. 7(a)-7(d), various installations of Applicant's handgun holder are depicted. In FIG. 7(a), a configured handgun holder 702 is mounted to a car console 704 with screws 730. The configured handgun holder 702 is configured for a secured storage application. The entire gun except for the handle is covered, providing maximum stability and protection. The configured handgun holder 702 holds the gun securely whether the lid on the console 704 is open or closed. The exact position of the gun is always known, allowing it to be quickly accessed for use.

In FIG. 7(b), a configured handgun holder 706 is mounted to the inside of a briefcase 708 by screws 732. A second configured handgun holder 710 is mounted to the inside of the briefcase 708 by screws 732. The configured handgun holder 706 is configured for a mix of secure storage and accessibility. The entire handle is exposed, allowing it to be readily grasped for use, yet the trigger is not exposed. In comparison, the configured handgun holder 710 is configured for maximum level of secured storage at the expense of reduced accessibility. The gun in the configured handgun holder 710 has very little of its handle exposed and is maximally protected. Both the gun in configured handgun holder 706 and the gun in configured handgun holder 710 are more accessible and better protected than the gun 712 disposed in the body of the briefcase 708.

In FIG. 7(c), a configured handgun holder 718 is mounted to the lower console 714 of a vehicle by screws 734. The configured handgun holder 718 is configured for a balance of secure storage and rapid access. The entire handle of the gun is exposed, but the trigger and most of the body of the gun is covered. This is an appropriate configuration for a vehicle because it can adequately secure the gun during the vibration, shaking, and bouncing as the vehicle moves, yet the entire handle of the handgun is presented for rapid deployment.

In FIG. 7(d), a configured handgun holder 722 is mounted to a tool box 720 using an adhesive. The configured handgun holder 722 is configured for rapid access and provides maximum accessibility. The entire handle and trigger of the gun are exposed, enabling it to be quickly deployed. The cut away sections of the handgun holder 722 lessen its security and storage features. However, in this application, where little movement is encountered and where accessibility is a primary concern, this configuration is appropriate.

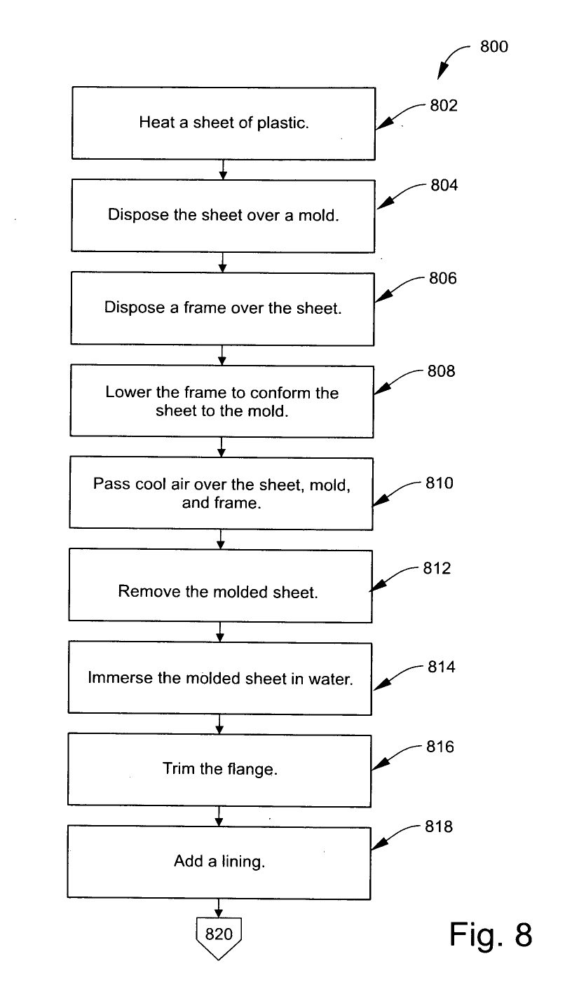

Referring to FIG. 8, a flowchart 800 containing the steps of one embodiment of making Applicant's handgun holder is depicted. At step 802, a sheet of plastic is heated to a point where it is pliable. In one embodiment, the sheet of plastic comprises a thermoplastic. In different embodiments, the sheet of plastic comprises a polycarbonate, acrylonitrile butadiene styrene (ABS), high-density polyethylene (HDPE), polyethylene terephthalate (PET), polyvinyl chloride (PVC), low-density polyethylene (LDPE), polypropylene (PP), or polystyrene (PS). In one embodiment, the sheet of plastic comprises ABS and is heated to about 275° F.

At step 804, the sheet of plastic is disposed over a mold. The mold has a raised portion that is sized and contoured to the desired interior cavity of the handgun holder. In one embodiment, the mold is configured according to the dimensions identified in FIGS. 1-3 in regards to the body portion 102 and in FIG. 5 in regards to the body portion 502, taking into account the thickness of the sheet. The mold also had a flat portion surrounding the raised portion.

In one embodiment, the mold includes an embodiment of the configuration mark sets described in FIG. 4. In one embodiment, the configuration mark sets are raised areas on the mold that will imprint the appropriate markings on the underside of the body portion 102 or 502 during formation.

At step 806, a frame is disposed over the heated sheet of plastic. In one embodiment, the interior opening in the frame conforms to the outline of the body portion 102 (in FIG. 1). In one embodiment, the interior opening in the frame conforms to the outline of the body portion 502 (in FIG. 5). In one embodiment, the interior opening in the frame is sized to conform to the outline of the body portion 102 or 502 with an additional clearance between all points along the inner edge of the frame and the corresponding points along the edge of the portion 102 or 502.

At step 808, the frame is lowered down on the sheet, which is lowered down over the mold. The frame pulls the heated, pliable plastic over the mold, thereby conforming the sheet to the shape of the mold. The flange is formed where the plastic is sandwiched between the frame and the flat portion of the mold.

At step 810, cool air is passed over the sheet, mold, and frame to aid in cooling the plastic. The cooled plastic is more rigid and will therefore retain its shape after being removed from the mold and frame. In one embodiment, ambient air is passed over the sheet, the mold, and the frame. In one embodiment, chilled air at approximately 65° F. is passed over the sheet, the mold, and the frame for about 30 seconds.

At step 812, the molded sheet is removed from the mold and the frame.

At step 814, the molded sheet is immersed in water to further cool and stiffen the sheet. In one embodiment, water at ambient temperature is used. In one embodiment, cooled water at about 60° F. is used and the molded sheet is immersed for 60 seconds.

At step 816, the flange is trimmed to a consistent and uniform width. In one embodiment, the flange is trimmed by a high-speed router running at approximately 2,300 RPM and then smoothed by sanding with a 100-grit belt sander running at approximately 1,500 RPM. In one embodiment, the flange is trimmed to achieve its final dimensions by die cutting.

At step 818, a lining is added to the interior surface of the body portion 102 (see FIG. 1) or 502 (see FIG. 5). In one embodiment, the lining is an anti-slip lining. In one embodiment, the lining is a felt lining. In one embodiment, the lining is substantially thick to accommodate handguns that are thinner than the height of the body portion 102/502 from the flange 104/504 (see FIG. 1/5). The manufacture of the handgun holder is now complete and the method transitions to step 820.

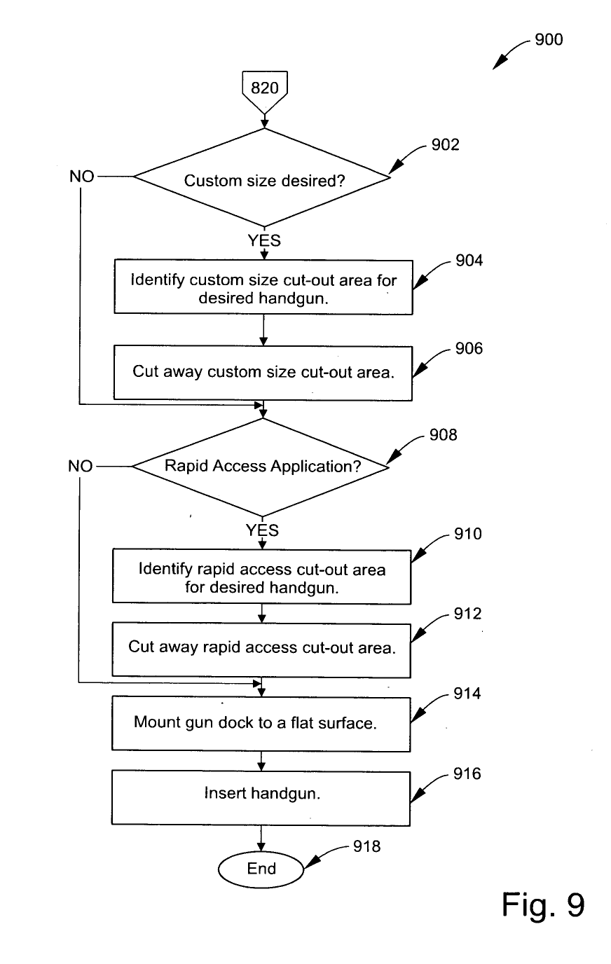

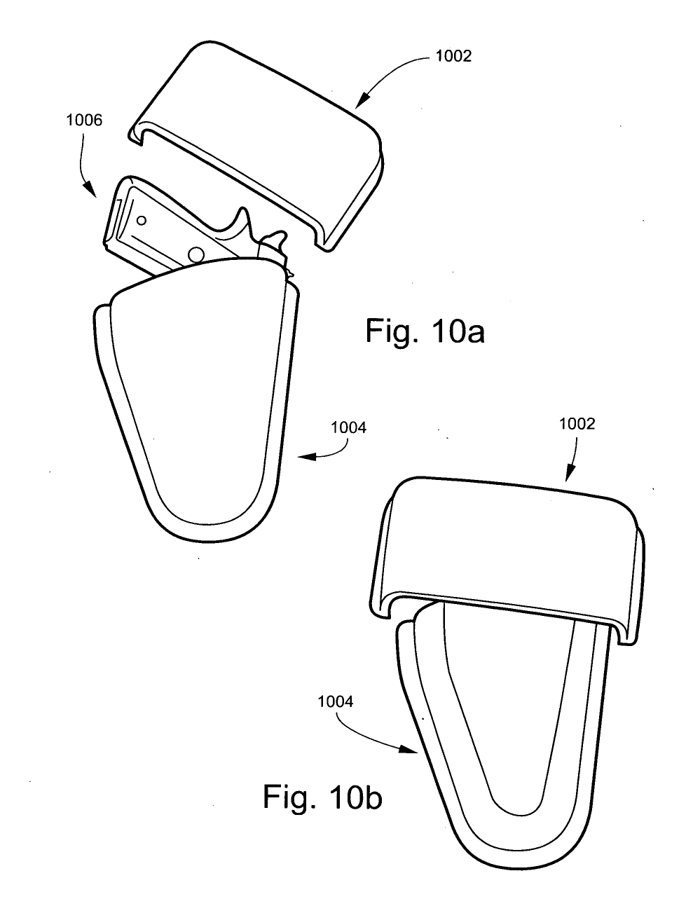

Referring to FIG. 9, a flowchart 900 containing the steps of one embodiment of configuring Applicant's handgun holder is depicted. The method begins at step 820.

At step 902, the method determines if the handgun holder will be customized to a specific handgun. This includes whether the handgun holder will be used in a secure storage configuration.

If the method determines at step 902 that the handgun holder will be configured to a specific handgun, the method transitions to step 904.

In step 904, the areas that must be cut away to configure the handgun holder to the desired handgun are identified. In one embodiment, the identification involves using the configuration mark sets and a set of specific configuration marks for the particular handgun. In one embodiment, the identification involves manually identifying the portions that need to be cut-away. In one embodiment, the identification involves scribing a line on the surface of the handgun holder representing the line or lines to cut.

In step 906, the identified area is cut away. The resultant shape of the handgun holder provides a custom configuration specific to the identified handgun and provides the maximum level of secure storage. The method transitions to step 908.

If the method determines at step 902 that the handgun holder will not be configured to a specific handgun, the method transitions to step 908.

In step 908, the method determines if the handgun holder will be configured for a rapid access application. If the method determines at step 908 that the handgun holder will be configured for a rapid access application, the method transitions to step 910.

In step 910, the areas that must be cut away to configure the handgun holder for a rapid access application are identified. In one embodiment, the identification involves using the configuration mark sets and a set of specific configuration marks for a rapid access application for the particular handgun. In one embodiment, the identification involves manually identifying the portions that need to be cut-away for rapid access applications. In one embodiment, the identification involves scribing a line on the surface of the handgun holder representing the line or lines to cut. The method then transitions to step 914.

If the method determines at step 908 that the handgun holder will not be configured for a rapid access application, the method transitions to step 914.

In step 914, the handgun holder is mounted to a flat surface. The surface need be flat only to the extent that a substantial portion of the flange must be able to simultaneously come into contact with the surface. The particular orientation will be determined by the specific application. In one embodiment, the handgun holder is mounted so the held gun has its barrel pointing down. In one embodiment, the handgun holder is mounted so the held gun has its barrel pointing horizontal. In one embodiment, the handgun holder is mounted so the held gun has its barrel pointing at an angle. The means to fasten the handgun holder to the surface also depends on the application. In different embodiments, the handgun holder is mounted to a surface by piercing the flange, such as by rivets, screws, nails, or combinations or equivalents thereof. In different embodiments, the handgun holder is mounted to a surface without piercing the flange, such as by glue, tape, or combinations or equivalents thereof. In different embodiments, the handgun holder 100 is removably mounted to a surface, such as by a hook and loop fastener.

In step 916, the handgun is inserted into the handgun holder, where it is securely stored, available for rapid access, or a balance of both. The method ends at 918.

Referring to the foregoing paragraphs, this invention is described in preferred embodiments in the following description with reference to the Figures, in which like numbers represent the same or similar elements, reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the above description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

While the invention is described through the above-described exemplary embodiments, it will be understood by those of ordinary skill in the art that modifications to, and variations of, the illustrated embodiments may be made without departing from the inventive concepts disclosed herein. For example, although some aspects of making and using Applicant's handgun holder have been described with reference to a flowchart, those skilled in the art should readily appreciate that functions, operations, decisions, etc. of all or a portion of each block, or a combination of blocks, of the flowchart may be combined, separated into separate operations or performed in other orders. Moreover, while the embodiments are described in connection with various illustrative data structures, one skilled in the art will recognize that the handgun holder may be embodied using a variety of dimensions. In addition, although a plastic handgun holder has been described, the disclosed methods and structures may be used with other materials, including other materials to fabricate other types of handgun holders. Furthermore, disclosed aspects, or portions of these aspects, may be combined in ways not listed above. Accordingly, the invention should not be viewed as being limited to the disclosed embodiment(s).

The present invention may be embodied in other specific forms without departing from its spirit or essential characteristics. The described implementations are to be considered in all respects only as illustrative and not restrictive. The scope of the invention should, therefore, be determined not with reference to the above description, but instead should be determined with reference to the pending claims along with their full scope or equivalents, and all changes which come within the meaning and range of equivalency of the claims are to be embraced within their full scope.

What is claimed is:

1. A hand tool storage device comprising:
a member substantially formed as a longitudinally bifurcated holder; and a substantially planar flange;
said substantially planar flange substantially circumscribing the periphery of the longitudinally bifurcated holder, wherein the flange is formed so as to make a confirming fit with an attachment surface.

2. The hand tool storage device as defined in claim 1, wherein the attachment surface is a substantially planar attachment surface.

3. The hand tool storage device as defined in claim 1 wherein the member substantially formed as a longitudinally bifurcated holder further comprises:
a top portion;
a right sidewall that runs substantially vertical and substantially the length of the firearm holder;
a left sidewall that is positioned substantially parallel to an upper portion of the right sidewall;
an angled left sidewall connected to the left sidewall at an angle between 20° and 30° from the left sidewall and toward the right sidewall;
a curved sidewall connecting the angled left sidewall and the right sidewall, wherein:
the right sidewall, the left sidewall, the angled left sidewall, and the curved sidewall each connect the flange and the top portion; and
an internal cavity defined by the top portion, the plane defined by the flange, the right sidewall, the left sidewall, the angled left sidewall, and the curved sidewall.

4. A method for making a hand tool storage device comprising the steps of:
a) heating a sheet of plastic;
b) disposing the heated sheet over a mold;
c) disposing a frame over the heated sheet;
d) lowering the frame to conform the heated sheet to the mold;
e) passing cool air over the sheet, mod and frame;
f) removing he molded sheet from the frame and mold;
g) trimming the molded sheet to create a storage device comprising:
a flange that defines a plane;
a top portion;
a right sidewall that runs substantially vertical and substantially the length of the firearm holder;
a left sidewall that is positioned substantially parallel to an upper portion of the right sidewall;
an angled left sidewall connected to the left sidewall at an angle between 20° and 30° from the left sidewall and toward the right sidewall;
a curved sidewall connecting the angled left sidewall and the right sidewall, wherein:
the right sidewall, the left sidewall, the angled left sidewall, and the curved sidewall each connect the flange and the top portion; and
an internal cavity defined by the top portion, the plane defined by the flange, the right sidewall, the left sidewall, the angled left sidewall, and the curved sidewall;
f) adding a lining to the storage device;
g) identifying at least one custom size cut-out areas for a desired hand tool; and
h) cutting away the at least one identified custom size cut-out area.

5. The method for making a hand tool storage device as defined in claim 4, further comprising the steps of:
a) identifying at least one rapid access cut-out area for a desired hand tool; and
b) cutting away the identified at least one rapid access cut-out area.

6. A kit for storing a hand tool comprising:
a) a storage device comprising:
a flange that defines a plane;
a top portion;
a right sidewall that runs substantially vertical and substantially the length of the firearm holder;
a left sidewall that is positioned substantially parallel to an upper portion of the right sidewall;
an angled left sidewall connected to the left sidewall at an angle between 20° and 30° from the left sidewall and toward the right sidewall;
a curved sidewall connecting the angled left sidewall and the right sidewall, wherein:
the right sidewall, the left sidewall, the angled left sidewall, and the curved sidewall each connect the flange and the top portion; and
an internal cavity defined by the top portion, the plane defined by the flange, the right sidewall, the left sidewall, the angled left sidewall, and the curved sidewall; and
b) a cover for concealing the stored hand tool.

7. The kit for storing a hand tool as defined in claim 6 wherein the cover is selected from the group comprising: a fabric flap and a piece of molded fabric.
